(19) United States
(12) Patent Application Publication
(10) Pub. No.: US 2007/0174012 A1
(43) Pub. Date: Jul. 26, 2007

(54) Method Of Determining Photomask Inspection Capabilities

(76) Inventors: Karen D. Badger, Georgia, VT (US); Emily F. Gallagher, Burlington, VT (US); Ian P. Stobert, Jeffersonville, VT (US); Alexander C.Y. Wei, Poughkeepsie, NY (US)

Correspondence Address: LAW OFFICE OF DELIO & PETERSON, LLC., 121 WHITNEY AVENUE, NEW HAVEN, CT, 06510, US

(21) Appl. No.: 11/275,695

(22) Filed: Jan. 25, 2006

(51) Int. Cl. G01N 37/00; G06F 19/00

(52) U.S. Cl. 702/83

(57) ABSTRACT

A method of and article for determining photomask inspection capabilities. The article comprises a photomask having a first array of a plurality of test pattern shapes that include ordered variations of a first shape variable, from a largest to a smallest dimension, and a second array of a plurality of test pattern shapes, that include the ordered variations of the first shape variable and further include ordered variations of a second shape variable, from a largest to a smallest dimension. The method includes inspecting the first array of test pattern shapes of the photomask in order of the variations of the first shape variable. If at least two consecutive first test pattern shapes in the first array fail an inspection criteria, the failed consecutive first test pattern shapes are marked as failed. The method then includes marking for inspection in the second array of test pattern shapes of the photomask those shapes having first shape variables in the vicinity of those of the failed consecutive first test pattern shapes, and inspecting the marked second array of test pattern shapes in order of the variations of the first shape variable. If at least two consecutive second test pattern shapes of the marked second array test pattern shapes fail an inspection criteria, the failed consecutive second test pattern shapes are marked as failed.

### BACKGROUND OF THE INVENTION

1. Field of the Invention

The present invention relates generally to lithographic production of microelectronic circuits or other features and, more particularly, to a method for determining inspection capabilities of photomasks used in lithographic production systems.

2. Description of Related Art

In the semiconductor industry, photolithography is used to transfer patterns or shapes from a photomask or reticle to a semiconductor wafer to form microelectronic circuits or other semiconductor device features. The patterns on the masks are designed to conform to dimensional rules determined by the lithographic processing parameters, semiconductor processing parameters, and circuit design criteria to ensure that the patterns transfer properly and the circuit functions. Once the layout of the circuit is created as a pattern on the photomask, the photolithographic process utilizes an exposure tool to project the mask patterns onto a layer of photoresist on the semiconductor wafer. As the critical dimensions (CDs) of the layout approach the resolution limit of the lithography equipment, proximity effects resulting from optical diffraction in the projection system begin to influence the manner in which features on a mask transfer to the resist layer such that the mask patterns and the initial design layout of patterns begin to differ.

Model-based optical proximity correction (OPC) is often employed to pre-distort features, on the basis of process simulations, in order that their dimensions achieve target values when printed on the wafer. Precise knowledge of mask inspection limits for a given mask process is highly desirable because OPC is optimized by adjusting feature sizes, but must do this within a pre-determined parameter space. With current mask inspection tools, some post-OPC design features are uninspectable because critical features or dimensions are difficult to resolve on a mask, or cause the mask inspection software to flag an intentional feature as a defect due to the difference between the die and the data.

If a clear definition of what is inspectable is known, then the data can be either designed or modified in OPC, taking these rules into account. If the rules are not clearly understood, then there is the risk of either generating data that is uninspectable, or imposing conservative design rules or OPC algorithms that could limit the OPC. Ideal rules precisely reflect what can and cannot be built and inspected. However, determining the rules for each mask process is challenging.

One way to identify inspection limits is to design test patterns, vary the dimensions of these test patterns, build a mask containing the patterns and then determine empirically which of these shapes passes mask inspection, as described in the U.S. Pat. Nos. 6,482,557 and 6,721,695. However, most of the patterns used in this approach are varied in an overly simple way across a pattern set. For example, the test patterns or shapes vary in one or two critical dimensions. This is due in part to the difficulties associated with mask inspection. When shapes that do not pass mask inspection are encountered, the tool flags the location. If too many of these flagged locations are present, the mask inspection is not completed. A large number of flagged inspection stops can be difficult to analyze efficiently, rendering the mask effectively uninspectable.

One way to avoid this problem is to lay out the shapes so that the set of inspectable and uninspectable shapes are in contiguous blocks. When the first set of uninspectable shapes is encountered, the operator can stop and make note of the location. This location is in itself a “result” since it corresponds to a defined region of uninspectable feature sizes. Large contiguous regions that contain uninspectable shapes can be treated as a “do not inspect region” (DNIR). This technique works only if there is a way to arrange the shapes such that inspectable shapes are grouped together. This segregation requires some prior knowledge of the tool.

While these methods are useful, they do not address some of the subtle factors that determine exact inspection limits. For example, corner rounding occurs in mask manufacturing. Because of this, a rule like minimum corner-to-corner distance between two rectangular shapes may actually depend on several variables, not simply two. In such cases, varying the dimensions of the smaller rectangle may change the corner rounding, and varying the vertical and horizontal displacement between the two rectangles effect the ability to inspect. In this example, there may be some combinations of values for fixed corner-to-corner distances that pass inspection. Another configuration with the same corner-to-corner value may fail inspection. There are many other examples of critical dimensions for mask inspection that can depend on several independent variables.

To cover a more complex inspection feature space, one could generate a complex set of test patterns with variations in many different critical dimensions and place these patterns in large array, varying 2, 3, 4 or even more variables in small gradations. However, this would likely result in an unmanageable inter-mixing of thousands of inspectable shapes with thousands of uninspectable ones. Repeating this methodology over several types of patterns would render the mask uninspectable, and impossible to analyze effectively due to the inspection stopping problem described earlier.

### SUMMARY OF THE INVENTION

Bearing in mind the problems and deficiencies of the prior art, it is therefore an object of the present invention to provide a method of determining photomask inspection capabilities that solves the problem of finding precise mask inspection limits for a given mask making process.

It is another object of the present invention to provide a method of determining photomask inspection capabilities that provide knowledge to a high degree of confidence of which geometries are inspectable, and which are not.

Still other objects and advantages of the invention will in part be obvious and will in part be apparent from the specification.

The above and other objects, which will be apparent to those skilled in the art, are achieved in the present invention which is directed to a method of and article for determining photomask inspection capabilities. The article comprises a photomask having thereon a first group of a plurality of test pattern shapes, wherein the first group includes ordered variations of a first shape variable, from a largest to a smallest dimension. The photomask also has thereon a second group of a plurality of test pattern shapes, wherein the second group includes the ordered variations of the first shape variable and further includes ordered variations of a second shape variable, from a largest to a smallest dimension.

The method of the present invention comprises providing the aforementioned photomask, preferably by generating the first and second group of pluralities of test pattern shapes, and transferring the groups of test pattern shapes onto a photomask. The method then includes inspecting the first group of test pattern shapes of the photomask in order of the variations of the first shape variable, from a largest to a smallest dimension. If at least two consecutive first test pattern shapes in the first group fail an inspection criteria, the failed consecutive first test pattern shapes are marked as failed. The method then includes marking for inspection in the second group of test pattern shapes of the photomask those shapes having first shape variables in the vicinity of those of the failed consecutive first test pattern shapes, and inspecting the marked second group of test pattern shapes in order of the variations of the first shape variable, from a largest to a smallest dimension. If at least two consecutive second test pattern shapes of the marked second group test pattern shapes fail an inspection criteria, the failed consecutive second test pattern shapes are marked as failed.

Preferably, the groups of a test pattern shapes are arranged in arrays, for example, arrays having rows and columns. The method of the present invention may further include, in each array, also marking as failed the test pattern shapes subsequent to the failed consecutive test pattern shapes. In the second group of test pattern shapes, the method preferably marks for inspection rows or columns in the vicinity of the failed consecutive first test pattern shapes.

The method may further include generating a third array of test pattern shapes. The third array includes the ordered variations of the first and second shape variables and further includes ordered variations of a third shape variable, from a largest to a smallest dimension. After marking the consecutive second test pattern shapes as failed, the method may then include marking for inspection in the third array of test pattern shapes of the photomask those shapes having first shape variables around those of the failed consecutive second test pattern shapes, and inspecting the marked third array test pattern shapes in order of the variations of the first shape variable, from a largest to a smallest dimension. If at least two consecutive second test pattern shapes of the marked third array test pattern shapes fail an inspection criteria, the failed consecutive third test pattern shapes are marked as failed.

At least one of the groups of test pattern shapes may include ordered variations of a dimension on an individual test pattern shape, ordered variations of a dimension of a protrusion on an individual test pattern shape, and/or ordered variations of a space dimension between individual test pattern shapes.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a flow chart illustrating the preferred method of determining photomask inspection capabilities in accordance with the present invention.

FIG. 2 is a plan view of a sub-arrays used in the method of the present invention, with a close-up view showing the layout of test patterns or shapes within the sub-array.

FIG. 3 is a plan view of one embodiment of a test pattern or shape to be used within the sub-array of FIG. 2, wherein the shape may be modified to vary two dimensions therein.

FIG. 4 is a plan view of another embodiment of a shape to be used within the sub-array of FIG. 2, wherein the shape may be modified to vary three dimensions therein.

FIG. 5 is a plan view of a further embodiment of a shape to be used within the sub-array of FIG. 2, wherein the shape may be modified to vary four dimensions therein.

FIG. 6 is a plan view of a test mask layout of nine arrays, with a close up of a portion of one array showing the sub-arrays therein.

### DESCRIPTION OF THE PREFERRED EMBODIMENT(S)

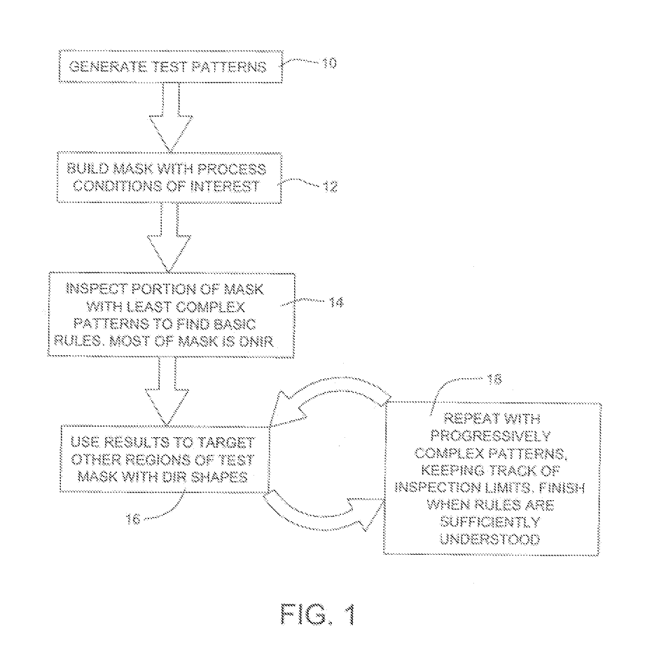

In describing the preferred embodiment of the present invention, reference will be made herein to FIGS. 1-6 of the drawings in which like numerals refer to like features of the invention.

The method for determining photomask inspection capabilities of the present invention includes first a method for generating test patterns, and a systematic method for arranging them on a mask data set. The method described will permit the generation of numerous, even millions, of different patterns in one mask, many of which are likely to be inspectable, and many of which are not. The arrangement of the test pattern layout permits any of the shapes present on the mask can be located easily.

Second, the method of the present invention includes a method of inspecting a mask containing the test patterns, which can be used to derive a good understanding of mask building and inspection capabilities. This technique will permit the inspection tool operator to find inspection limits without stopping on the majority of uninspectable features on the mask. The method of the present invention permits the study and analysis of thousands or even millions of different geometries with respect to their ability to be inspected, without actually having to inspecting most of them.

The flow chart of FIG. 1 provides an overview of the preferred method of the present invention. Test patterns or shapes are generated 10 that would include ordered variations of one or more shape variable, and the patterns are then formed and arranged on a mask 12 so as provide an opportunity to test variables or conditions of interest. The layout of the individual test patterns or shapes is important in practicing the method of the invention. The test patterns or shapes are systematically grouped by rule type with patterns of varying complexity, where complexity is measured by the number of variables that are modified within the patterns. In a preferred embodiment, the simplest patterns or shapes will have one critical dimension that varies through an array of shapes, such as width or space. In the set of patterns or shapes that are slightly more complex, the shapes may vary in two ways through an array, but the critical dimension from the simpler array will match, making it easy for the user to find similar geometries in different parts of the layout that have a critical dimension in common.

A simple basic array may comprise test patterns or shapes of isolated rectangles of fixed height, and of varying widths. The widths may be large at the bottom of the array, and then decreased in 1 nm increments with each row. In the next, more complex test pattern, one could test the effect of varying degrees of shape nesting on the basic width rule. The basic pattern from the previous array could be reused, but the different columns could be used to create nested copies on the basic rectangle, varying both the widths and the spacing. Other types of test patterns or shapes may be employed.

For the third array of shapes, the effect of varying the height of the rectangles as well as the width and spacing may be investigated. To vary three variables, the shapes are preferably grouped into a large array with sub arrays. The use of both major and minor column and row indices provides four independent variables with which to work. However, even in this scenario, the row indices could be used in the same way as with the first array, so that the principle width in question will match between the i^{th} row of the complex array, and of the original simple array. The method continues in this vein, creating increasingly complex patterns. The method preferably documents the layout rules so that a user can target specific geometries as “do inspect regions” (DIRs), with variables in narrowed ranges, to avoid having to inspect all or larger regions of the chip.

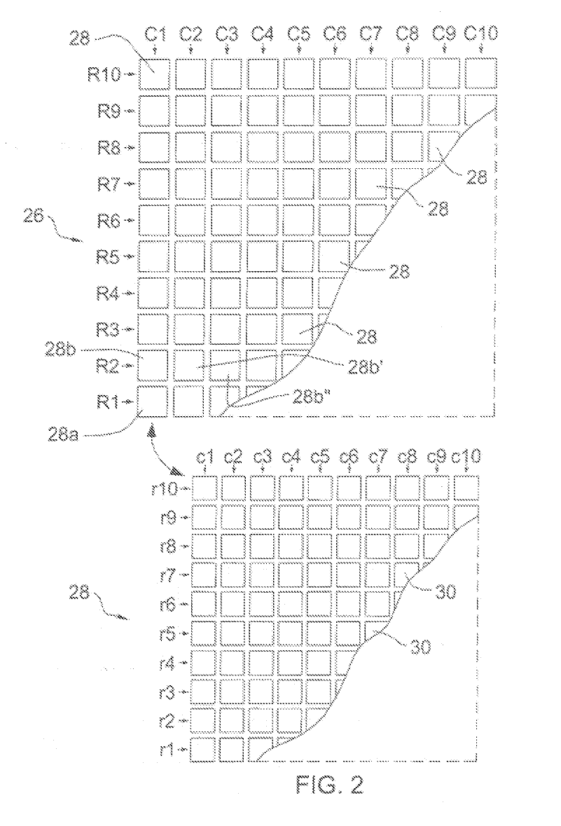

FIG. 2 shows one embodiment of the test pattern or shape layout of sub-array 26, which in the example is made up of 10,000 test patterns or shapes. Sub-array 26 is itself shown as being made up of a 10×10 arrangement of basic arrays 28, each of which comprises a 10×10 array of individual test patterns or shapes 30, shown without detail. Each sub-array 26 contains major columns, here labeled C1 through C10, and major rows, here labeled R1 through R10. Each basic array 28, located at the intersection of a major column and major row, has minor columns of individual shapes 30, labeled c1 through c10, and minor rows, labeled r1 through r10. Thus, in the example shown, each of the major columns C1, C2, C3, . . . , C10 in sub-array 26 contains minor columns c1, c2, c3, . . . , c10, and each of the major rows R1, R2, R3, . . . , R10 in the sub-array contains minor rows r1, r2, r3, . . . , r10.

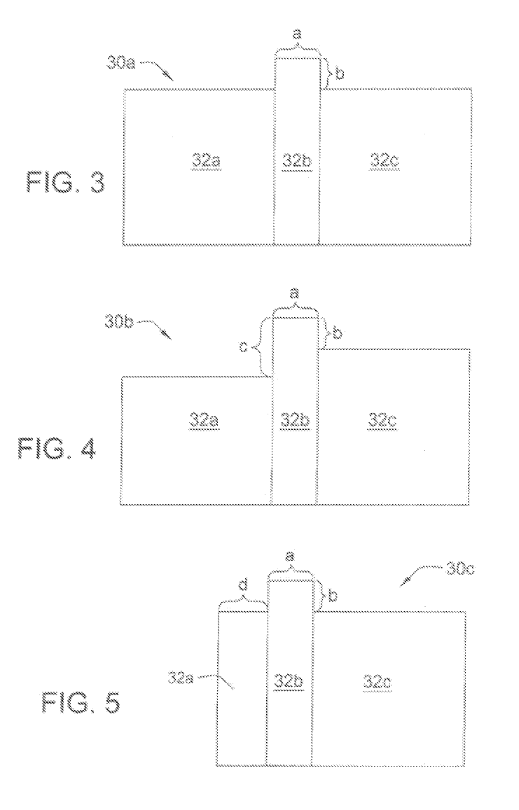

One example of a test pattern or shape to be used in the basic array 28 is shown in FIG. 3, where shape 30a is generated to test a so-called nub rule, i.e., the determination of what type of protrusions are allowable from a basic shape on a mask intended to be projected. Such protrusions or nubs are commonly created by model-based optical proximity correction (OPC), in which mask shapes are pre-distorted on the basis of process simulations in order that their dimensions, as printed on the wafer, achieve target values. Shape 30a is made up of adjacent contacting rectangles 32a, 32b and 32c, with an end portion of rectangle 32b forming a nub or protrusion extending beyond the upper edges of rectangles 32a and 32b. The dimensions of interest on the shape are the width of the nub a, and the length of projection b. In general, for mask inspection, nubs that are narrow and extend further (i.e., small width a, long length b) are problematic, whereas nubs that are shallower are less of a problem.

In basic array 28, shape 30a would be generated in each of the positions so that the nub portion is centered at the intersection of each minor column and row. The width of the nub would be varied between each minor column, and the length of projection would be varied in each minor row. For example, the width dimension a would be fixed at a desired dimension in minor column c1, and would decrease in 1 nm increments from c1 to c10. Likewise, the length dimension b would be fixed at a desired dimension in minor row r1, and would decrease in 1 nm increments from r1 to r10. Thus, for example, nub width a may vary sequentially from 35 nm to 26 nm in minor columns c1 to c10, while nub length b may vary sequentially from 50 nm to 41 nm in minor rows r1 to r10. Every combination of nub width and length, within a dimension difference of 10 nm for each, would therefore be present in the basic array. If the nub variables embodied in shape 30a are the simplest pattern to be tested, the basic array 28a containing the shape 30a variations may be located on the left-most major column C1 and lowest major row R1 of sub-array 26.

In order to probe the intricacies of the nub rule, another test shape 30b may be generated to create a more complex pattern in a different basic array. FIG. 4 shows test shape 30b which is generated again from adjacent contacting rectangles 32a, 32b and 32c. However, in this shape, the nub again has width a, but the nub protrusion has a right side length b, extending from the upper edge of rectangle 32c, and a different left side length c, extending from the upper edge of rectangle 32a. Since there are now three (3) variables to generate and test, width a and lengths b and c, more than one basic array 28 must be employed. The variations of these dimensions may be made by varying shape 30b nub width a and left side length b by minor column and minor row within one basic array 26, in the manner of shape 30a, while keeping the same left side length c within that entire basic array. To explore variation of the nub left side length c, the basic array in the next major column or major row would have the same nub width a and left side length b in its array of minor columns and minor rows, but would have the nub left side length c an incremental size smaller, for the entire basic array. The more complex patterns of nub dimensions a, b and c would be placed in higher columns or rows within sub-array 26. For example, basic array 28b at position C1, R2 may have nub left side length c fixed at 50 nm, while nub width a varies sequentially from 35 nm to 26 nm in minor columns c1 to c10 and nub right side length b varies sequentially from 50 nm to 41 nm in minor rows r1 to r10. The adjacent basic array 28b′ at position C2, R2 may have nub left side length c fixed at the next sequential value 60 nm, while nub width a and nub right side length b vary using the same dimensions in minor columns c1 to c10 and minor rows r1 to r10 as in basic array 28b. The next basic array 28b″ at position C3, R2 would still have the same variations in nub dimensions a and b as in basic arrays 28b and 28b′, but would fix nub left side length c at the next sequential value 70 nm. The nub left side length would continue to change by the same increment with increasing major column position, C4 through C10.

FIG. 5 shows another test shape 30c again made up of adjacent contacting rectangles 32a, 32b, 32c. In this shape, again the nub width and nub protrusion length variables a and b are tested as in shape 30a, but with a different third variable, distance d from the upper left corner of rectangle 32a. These three variables may be varied in the same manner as described in connection with test shape 30b, except that corner distance d is kept fixed within each basic array (with dimensions a and b varied by minor column and minor row), but sequentially varied by major column or major row from one adjacent basic array to the next.

Four or more variables may also be tested, for example, by combining shape 30b with shape 30c. In this case of four variables, the variables would be nub width a, nub right side length b, nub left side length c, and nub distance to corner d. While the variations in nub dimensions a, b and c would be set out in the manner described in connection with basic arrays 28b. 28b′ and 28b″, the dimension of the fourth variable d would be varied in the major row position, from a larger value to a smaller value.

Four or fewer variables use two-level nesting, where the sub arrays have major rows and columns as well as minor rows and columns (on the basic array level). To test more than four variables, preferably additional levels of nesting would be used. For example, up to six variables may be tested using a three-tiered level of nesting, where an additional array level below the basic array would be made up of rows and columns of test shapes in place of each individual test shape 30 shown in FIG. 2. An additional array level below this, again made up of more rows and columns or test shapes, would provide testing of eight variables in a four tiered level of nesting.

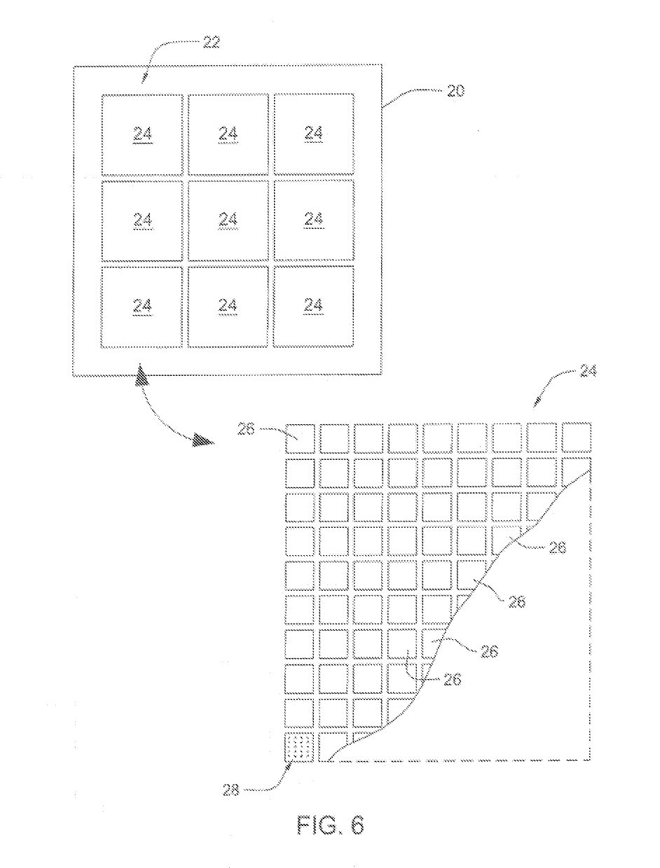

As shown in FIG. 6, sub-arrays 26, each of about 1 mm ×1 mm in dimension, for example, are arranged in a 9×10 array to form a main array 24. A plurality of main arrays 24, each of a size of about 9 mm ×10 mm, are laid out in a 3×3 arrangement 22 which may contain about one million of the test patterns or shapes. Photomask 20 of the type used in lithographic production may have transferred thereon identical or different main arrays 22, in any other number, more or less, as desired. The reason for using multiple copies of the same test pattern on a reticle are two-fold. First, it allows the experimenter to have multiple versions of the same test patterns on a reticle, so that results can be verified with a larger statistical sample; second, it allows the experimenter to see if there are any systemic across-reticle variations that need to be taken into account.

After the mask is built using the lithographic process and tool of interest, inspection is commenced 16 (FIG. 1). The chip can be globally covered by a DNIR region, except for the simplest rule regions. At the inspection tool, the layouts are preferably arranged so that the target pattern or shape geometries which are known to pass are inspected first. As the inspection tool scans from the simpler to the more complex variables, real defects are dealt with as usual. When a contiguous block of test pattern fails is encountered in a basic array, the operator makes note of the location, and then skips over to the next simple test pattern in the next basic array, using a new DNIR if needed. After all of the simple patterns have been inspected, the failing regions are analyzed, and the failing values are noted. Next, for each of these failing values, the corresponding regions of the more complex patterns are identified 16, which should have approximately the same critical dimension. These regions are then punched out with DIR regions of sufficiently small size to be inspectable regardless of the number of fails. The inspection process is now repeated, again taking note of the failing test pattern sites. This iterative process is repeated 18, moving to increasingly complex patterns as needed, while keeping track of inspection limits. This is continued until the rules of the inspection limits are sufficiently understood.

An example of the inspection procedure is inspection of basic array 28, as shown in FIG. 2. The inspection of the test patterns or shapes would begin at minor row r1 of basic array 28a, and move sequentially across the columns c1 through c10 and then sequentially up each next minor row r2 through r10. If all the test patterns 30 pass, the same inspection sequence is begun for the next adjacent basic array. If a test pattern fails, the location of the failure on the basic array is noted, and the remaining rows and columns of that basic array are marked DNIR, and the inspection of that basic array is terminated. When commencing the inspection of the next basic array, instead of beginning again with minor row r1 and minor column c1, the inspection would instead begin at a minor row and minor column in the vicinity of those of the failed consecutive first test pattern shapes in the previous basic array. For example, if the inspection of basic array 28b showed that the failure commenced at minor row r5, then the rows around minor row r5 of basic array 28b′ would be marked DIR, such as minor rows r3 through r7. Thus, the inspection of basic array 28b′ would skip over the preceding minor rows r1 and r2, which would be marked DNIR, and would instead begin well into the basic array at minor row r3. If the inspection of basic array 28b′ then showed failure of a test pattern commencing at the position at minor row r5 and minor column c7, then the remaining shapes of that basic array would be marked DNIR. When commencing the inspection of the next basic array, 28b″, the shapes in the vicinity of the position at minor row r5 and minor column c7 of that basic array would be marked DIR, such as minor rows r3 through r7 and minor columns c5 through c9, and the inspection would be able to skip over the shapes at the prior and subsequent rows and column positions.

Thus, the present invention provides a method of determining photomask inspection capabilities that permits identification of precise mask inspection limits and reduces the number of test pattern shapes to be inspected, while providing a high degree of confidence in understanding which test pattern geometries are inspectable and which are uninspectable.

While the present invention has been particularly described, in conjunction with a specific preferred embodiment, it is evident that many alternatives, modifications and variations will be apparent to those skilled in the art in light of the foregoing description. For example, the number and types of shapes in the basic arrays, as well as the number of basic arrays, may be determined by the requirements of the tests to be performed. More than four variables may also be tested. It is therefore contemplated that the appended claims will embrace any such alternatives, modifications and variations as falling within the true scope and spirit of the present invention.

Thus, having described the invention, what is claimed is:

1. A method of determining photomask inspection capabilities comprising:
generating a first group of a plurality of test pattern shapes, the first group including ordered variations of a first shape variable, from a largest to a smallest dimension;
generating a second group of a plurality of test pattern shapes, the second group including the ordered variations of the first shape variable and further including ordered variations of a second shape variable, from a largest to a smallest dimension;
transferring the groups of test pattern shapes onto a photomask;
inspecting the first group of test pattern shapes of the photomask in order of the variations of the first shape variable, from a largest to a smallest dimension;
if at least two consecutive first test pattern shapes in the first group fail an inspection criteria, marking the failed consecutive first test pattern shapes failed;
marking for inspection in the second group of test pattern shapes of the photomask having first shape variables in the vicinity of those of the failed consecutive first test pattern shapes;
inspecting the marked second group of test pattern shapes in order of the variations of the first shape variable, from a largest to a smallest dimension; and
if at least two consecutive second test pattern shapes of the marked second group test pattern shapes fail an inspection criteria, marking the failed consecutive second test pattern shapes as failed.

2. The method of claim 1 wherein the groups of test pattern shapes are arranged in arrays.

3. The method of claim 1 further including generating a third array of test pattern shapes, the third array including the ordered variations of the first and second shape variables and further including ordered variations of a third shape variable, from a largest to a smallest dimension; and, after marking the consecutive second test pattern shapes as failed:
marking for inspection in the third array of test pattern shapes of the photomask those shapes having first shape variables around those of the failed consecutive second test pattern shapes;
inspecting the marked third array test pattern shapes in order of the variations of the first shape variable, from a largest to a smallest dimension; and
if at least two consecutive second test pattern shapes of the marked third array test pattern shapes fail an inspection criteria, marking the failed consecutive third test pattern shapes as failed.

4. The method of claim 2 further including, in each array, also marking as failed the test pattern shapes subsequent to the failed consecutive test pattern shapes.

5. The method of claim 1 wherein at least one of the groups of test pattern shapes includes ordered variations of a dimension on an individual test pattern shape.

6. The method of claim 1 wherein at least one of the groups of test pattern shapes includes ordered variations of a dimension of a protrusion on an individual test pattern shape.

7. The method of claim 1 wherein at least one of the groups of test pattern shapes includes ordered variations of a space dimension between individual test pattern shapes.

8. The method of claim 1 wherein the first and second groups of a test pattern shapes are arranged in arrays having rows and columns, and wherein the second group of test pattern shapes has marked for inspection rows or columns in the vicinity of the failed consecutive first test pattern shapes.

9. A method of determining photomask inspection capabilities comprising:
providing a photomask having thereon a first group of a plurality of test pattern shapes, the first group including ordered variations of a first shape variable, from a largest to a smallest dimension and a second group of a plurality of test pattern shapes, the second group including the ordered variations of the first shape variable and further including ordered variations of a second shape variable, from a largest to a smallest dimension;
inspecting the first group of test pattern shapes of the photomask in order of the variations of the first shape variable, from a largest to a smallest dimension;
if at least two consecutive first test pattern shapes in the first group fail an inspection criteria, marking the failed consecutive first test pattern shapes as failed;
marking for inspection in the second group of test pattern shapes of the photomask those shapes having first shape variables in the vicinity of those of the failed consecutive first test pattern shapes;
inspecting the marked second group of test pattern shapes in order of the variations of the first shape variable, from a largest to a smallest dimension; and
if at least two consecutive second test pattern shapes of the marked second group test pattern shapes fail an inspection criteria, marking the failed consecutive second test pattern shapes as failed.

10. The method of claim 9 wherein the groups of test pattern shapes are arranged in arrays.

11. The method of claim 9 further including generating a third array of test pattern shapes, the third array including the ordered variations of the first and second shape variables and further including ordered variations of a third shape variable, from a largest to a smallest dimension; and, after marking the consecutive second test pattern shapes as failed:
marking for inspection in the third array of test pattern shapes of the photomask those shapes having first shape variables around those of the failed consecutive second test pattern shapes;
inspecting the marked third array test pattern shapes in order of the variations of the first shape variable, from a largest to a smallest dimension; and
if at least two consecutive second test pattern shapes of the marked third array test pattern shapes fail an inspection criteria, marking the failed consecutive third test pattern shapes as failed.

12. The method of claim 10 further including, in each array, also marking as failed the test pattern shapes subsequent to the failed consecutive test pattern shapes.

13. The method of claim 9 wherein at least one of the groups of test pattern shapes includes ordered variations of a dimension on an individual test pattern shape.

14. The method of claim 9 wherein at least one of the groups of test pattern shapes includes ordered variations of a dimension of a protrusion on an individual test pattern shape.

15. The method of claim 9 wherein at least one of the groups of test pattern shapes includes ordered variations of a space dimension between individual test pattern shapes.

16. The method of claim 9 wherein the first and second groups of test pattern shapes are arranged in arrays having rows and columns, and wherein the second group of test pattern shapes has marked for inspection rows or columns in the vicinity of the failed consecutive first test pattern shapes.

17. An article for determining photomask inspection capabilities comprising a photomask having thereon a first group of a plurality of test pattern shapes, the first group including ordered variations of a first shape variable, from a largest to a smallest dimension and a second group of a plurality of test pattern shapes, the second group including the ordered variations of the first shape variable and further including ordered variations of a second shape variable, from a largest to a smallest dimension.

18. The article of claim 17 wherein the first and second groups of test pattern shapes are arranged in arrays having rows and columns.

19. The article of claim 17 wherein the photomask further includes a third array of test pattern shapes, the third array including the ordered variations of the first and second shape variables and further including ordered variations of a third shape variable, from a largest to a smallest dimension.

20. The article of claim 17 wherein at least one of the groups of test pattern shapes includes ordered variations of a dimension on an individual test pattern shape, a dimension of a protrusion on an individual test pattern shape, or a space dimension between individual test pattern shapes.
